(19) United States
(12) Patent Application Publication
(10) Pub. No.: US 2010/0270100 A1
(43) Pub. Date: Oct. 28, 2010

(54) Electric Power Steering Device

(76) Inventors: Hirotatsu Ikeno, Gunma (JP); Eiichi Machida, Gunma (JP); Masayuki Okubo, Gunma (JP)

Correspondence Address: WENDEROTH, LIND & PONACK, L.L.P., 1030 15th Street, N.W.,, Suite 400 East, Washington, DC, 20005-1503, US

(21) Appl. No.: 12/087,547

(22) PCT Filed: Feb. 1, 2007
(86) PCT No.: PCT/JP2007/001671

§ 371 Date: Aug. 18, 2008

(30) Foreign Application Priority Data
Feb. 2, 2006 (JP) 2006-025402

(51) Int. Cl. H02K 1/14; B62D 5/04

(52) U.S. Cl. 180/443; 310/216.111

(57) ABSTRACT

A rack-assist type electric power steering device (10) uses a motor (1) as a drive source. The stator (11) of the motor (1) includes a stator core (13) having ring-like yoke portion (16) and teeth (17) projecting from the yoke portion (16) in the inner direction. In the stator core (13), the ratio (Wy:Wt) between the width (Wy) of the yoke portion (16) in the radial direction and the width (Wt) of the teeth (17) in the circumferential direction is 1:1.4 to 1.8. By setting the yoke portion (16) and the teeth (17) of the stator core (13) to this value, the stator core (13) can be set such that torque slack is difficult to occur within a restricted space

### TECHNICAL FIELD

The present invention relates to an electric power steering device using an electric motor as a drive source and, more particularly to, a rack-assist type electric power steering apparatus in which a rack shaft for a steering system used in an automobile is inserted through a motor center portion.

### BACKGROUND ART

In recent years, in order to assist a steering force of a vehicle and the like, a so-called power steering device is provided in many vehicles. In particular, an electric power steering device is most widely used in vehicles recently in terms of a reduction in engine load or a reduction in weight. The electric power steering device (hereinafter, sometimes abbreviated as “EPS”) is generally applied to a rack-and-pinion type steering device and is roughly classified into three types depending on the position of motor. Namely, from the side near a driver, the three types such as a column assist type in which the motor is provided on the steering shaft; a pinion assist type in which a motor is provided at the connection portion between the steering shaft and the rack shaft; and a rack assist type in which a motor is coaxially provided with the rack shaft are known.

An EPS disclosed in Patent Document 1 is the rack-assist type device. To the rack-assist type EPS, a steering assist force is given by a motor coaxially provided with the rack shaft. FIG. 6 is a cross-sectional view showing a configuration of a rack-assist type EPS like one disclosed in Patent Document 1. In an EPS 51 of FIG. 6, a motor 53 is coaxially provided with a rack shaft 52. A steering assist force generated by the motor 53 is transmitted to the rack shaft 52 through a ball screw mechanism 54. Steering control wheels are connected to both ends of the rack shaft 52 through a not shown tie rod, knuckle arm, and the like. The rack shaft 52 is rack-and-pinion coupled to a steering shaft 55 and is moved in the axial direction (left-right direction in the figure) by driver's steering operation. The motor 53 has a structure in which a magnet 57, a cylindrical rotor shaft 58 and a rotor core 59 are coaxially inserted into a cylindrical yoke 56. The rack shaft 52 is inserted through the rotor shaft 58.

In the EPS 51, when a steering wheel is operated to rotate the steering shaft 55, the rack shaft 52 is moved in the direction corresponding to the rotation, whereby the steering operation is made. As a result, a not shown steering torque sensor is activated, and a power is appropriately supplied to the motor 53 based on the detected torque. When the motor 53 is activated, the rotation thereof is transmitted to the rack shaft 52 through the ball screw mechanism 54. That is, the rotation of the motor 53 is converted into movement in the axial direction of the rack shaft 52 by the ball screw mechanism 54, whereby a steering assist force is given to the rack shaft 52. The steering control wheels are steered by the steering assist force and a manual steering force, thereby alleviating the load of the steering wheel operation of a driver.

Patent Document 1: Jpn. Pat. Appln. Laid-Open Publication No. 10-152058
Patent Document 2: Jpn. Pat. Appln. Laid-Open Publication No. 2000-78780
Patent Document 3: Jpn. Pat. Appln. Laid-Open Publication No. 2001-218439
Patent Document 4: Jpn. Pat. Appln. Laid-Open Publication No. 2003-158856

### DISCLOSURE OF THE INVENTION

### Problems to be Solved by the Invention

On the other hand, the rack-assist type EPS as shown in FIG. 6 easily interferes with the engine layout and, therefore, a strict restriction is often imposed on the physical size (particularly, outside dimension) thereof. For example, with regard to an EPS for compact vehicles, one with the outer diameter exceeding 100 mm lacks marketability. Thus, in the rack-assist type EPS, it is necessary to constitute a motor capable of achieving the optimum specification that meets required performance within 100 mm outer diameter. Meanwhile, the rack shaft penetrating the inside of the motor has an outer diameter of about 20 to 30 mm. Accordingly, the rotor shaft through which the rack shaft is inserted needs to have an inner diameter of about 20 to 40 mm. That is, in the configuration in which the rack shaft penetrates the center of the motor, the outer diameter of the motor for rack-assist type EPS needs to fall within 100 mm and, further, a desired output must be realized with the mentioned physical size. In addition, the motor for EPS is required to achieve low friction (rotational resistance at non-energization time), low torque ripple, and low cost.

However, such a compact, high-performance, and low-cost EPS motor requires very delicate and complicated adjustment in determining its specification. That is, various parameters such as a configuration of a stator or rotor, a magnet, and a winding are involved in the design of the motor structure. Further, these parameters often have trade-off relationships. Therefore, it is often difficult for even skilled designers to set the specification such that the above respective elements achieve predetermined performance requirements. For example, when focusing, as one of the abovementioned elements, on a magnetic circuit section constituted by the stator and rotor, a trade-off relationship exists between the physical size (stator dimension) and securement of a sufficient torque, in terms of flux saturation.

That is, the stator is used as a flux path in the motor, so that as the dimension of the stator becomes small, a magnetic resistance increases with the result that the flux saturation may easily occur. Thus, in a motor having a small stator core, the flux saturation occurs in the core, which reduces an output torque at high load time (high torque time). FIG. 7 is an explanatory view showing a relationship between a stator core shape and motor torque. As shown in FIG. 7, when the stator core is small, a torque slack occurs (torque increasing rate is decreased) at high load time such as a stationary steering due to influence of the flux saturation in the stator core. When a dimensional allowance is provided for fear of the magnetic saturation so as to secure a torque, the physical size increases and/or coil winding space is reduced, resulting in uncompetitive products. Thus, it is difficult to achieve both the securement of a sufficient torque and miniaturization at the same time in the EPS motor, which interferes with achievement of further miniaturization and higher performance of the EPS.

An object of the present invention is to achieve both the securement of a sufficient torque and miniaturization at the same time in the EPS motor to thereby optimally reduce the size of an electric power steering device without deteriorating its performance and assembling property.

### Means for Solving the Problems

According to an aspect of the present invention, there is provided an electric power steering device having a rotor with a permanent magnet and a stator arranged on an outer peripheral side of the rotor, characterized in that the stator has a stator core provided with a ring-like yoke portion and a teeth portion projecting from the yoke portion in the inner direction, and the stator core is formed such that the ratio of a magnetic resistance value between the yoke portion and teeth portion is set in a range from 1:1.4 to 1:1.8.

In the present invention, by setting the ratio of the magnetic resistance value between the yoke portion and teeth portion of the stator core in the range from 1:1.4 to 1:1.8, the stator core of the EPS motor can be set so that torque slack (decrease in torque increasing rate) is difficult to occur within a restricted space. As a result, there can be provided a compact and high-performance EPS motor excellent in layout and achieving high torque linearity can be provided, thereby achieving further miniaturization and higher performance of the EPS. Further, the stator core is formed in an optimum shape to eliminate unnecessary portions, so that cost and weight of the EPS motor can be reduced, thereby enhancing the marketability of the EPS. Further, in designing the motor, it is possible to determine the ratio of the magnetic resistance value between the yoke portion and teeth portion previously to some degree, thereby reducing man-hour required for designing the EPS.

According to another aspect of the present invention, there is provided an electric power steering device having a rotor with a permanent magnet and a stator arranged on an outer peripheral side of the rotor, characterized in that the stator has a stator core provided with a ring-like yoke portion and a teeth portion projecting from the yoke portion in the inner direction, and the stator core is formed such that the ratio Wy:Wt between a width Wy of the yoke portion in the radial direction and width Wt of the teeth portion in the circumferential direction is set in a range from 1:1.4 to 1:1.8.

In the present invention, by setting the ratio between Wy and Wt in the range from 1:1.4 to 1:1.8, the stator core of the EPS motor can be set so that torque slack is difficult to occur within a restricted space. As a result, there can be provided a compact and high-performance EPS motor excellent in layout and achieving high torque linearity, thereby achieving further miniaturization and higher performance of the EPS. Further, the stator core is formed in an optimum shape to eliminate unnecessary portions, so that cost and weight of the EPS motor can be reduced, thereby enhancing the marketability of the EPS. Further, in designing the motor, it is possible to determine the ratio between Wy and Wt previously to some degree, thereby reducing man-hour required for designing the EPS motor.

In the electric power steering device, the motor may be coaxially provided around a rack shaft connected to steering control wheels so as to supply a steering assist force to the rack shaft.

### ADVANTAGES OF THE INVENTION

In an electric power steering device of the present invention, which has a rotor with a permanent magnet and a stator arranged on an outer peripheral side of the rotor, the stator has a stator core provided with a ring-like yoke portion and a teeth portion projecting from the yoke portion in the inner direction, and the stator core is formed such that the ratio of the magnetic resistance value between the yoke portion and teeth portion is set in a range from 1:1.4 to 1:1.8. Thus, it is possible to obtain a configuration, within a strict physical size restriction, that makes it difficult for the torque slack to occur in the stator core of the EPS motor whose physical size is strictly restricted. Therefore, according to the present invention, an EPS using a compact and high-performance motor excellent in layout and achieving high torque linearity can be provided, thereby achieving further miniaturization and higher performance of the EPS.

Further, the stator core is formed in an optimum shape to eliminate unnecessary portions, so that cost and weight of the EPS motor can be reduced. Accordingly, cost and weight of the EPS can also be reduced, thereby enhancing the marketability of the EPS. Further, in designing the motor, since it is possible to determine the ratio of the magnetic resistance value between the yoke portion and teeth portion previously to some degree, an optimum motor design guideline for the EPS can be obtained to make it easier to constitute a compact, high-output, and low cost EPS motor than ever before, resulting in a reduction of man-hour required for designing the EPS. As a result, product development cost can be reduced and, accordingly, production cost of the EPS can be reduced.

In another electric power steering device of the present invention, which has a rotor with a permanent magnet and a stator arranged on an outer peripheral side of the rotor, the stator has a stator core provided with a ring-like yoke portion and a teeth portion projecting from the yoke portion in the inner direction, and the stator core is formed such that the ratio Wy:Wt between a width Wy of the yoke portion in the radial direction and width Wt of the teeth portion in the circumferential direction is set in the range from 1:1.4 to 1:1.8. Thus, it is possible to obtain a configuration, within a strict physical size restriction, that makes it difficult for the torque slack to occur in the stator core of the EPS motor whose physical size is strictly restricted. Therefore, according to the present invention, an EPS using a compact and high-performance motor excellent in layout and achieving high torque linearity can be provided, thereby achieving further miniaturization and higher performance of the EPS.

Further, the stator core is formed in an optimum shape to eliminate unnecessary portions, so that cost and weight of the EPS motor can be reduced. Accordingly, cost and weight of the EPS can also be reduced, thereby enhancing the marketability of the EPS. Further, in designing the motor, since it is possible to determine the ratio of the magnetic resistance value between the yoke portion and teeth portion previously to some degree, an optimum motor design guideline for the EPS can be obtained to make it easier to constitute a compact, high-output, and low cost EPS motor than ever before, resulting in a reduction of man-hour required for designing the EPS motor. As a result, product development cost can be reduced and, accordingly, production cost of the EPS can be reduced.

### BRIEF DESCRIPTION OF THE DRAWINGS

FIG. 1 is a cross-sectional view showing a configuration of an electric power steering device which is an embodiment of the present invention;

FIG. 2 is an enlarged cross-sectional view showing a configuration of a motor used in the electric power steering device of FIG. 1;

FIG. 3 is an explanatory view showing a configuration of a stator core in the motor of FIG. 2;

FIG. 4 is an explanatory view showing a flux flow in the stator core;

FIG. 5 is an explanatory view showing a relationship between an effective flux and torque at the time when a teeth width is changed;

FIG. 6 is a cross-sectional view showing a configuration of a rack-assist type EPS; and

FIG. 7 is an explanatory view showing a relationship between a stator core shape and motor torque.

### EXPLANATION OF REFERENCE SYMBOLS

1: Motor
2: Rack shaft
3: Ball screw mechanism
4: Steering shaft
10: Electric power steering device
11: Stator
12: Housing
13: Stator core
14: Winding
15: Power supply wiring
16: York portion
17: Teeth
18: Slot
21: Rotor
22: Rotor shaft
23: Rotor core
24: Magnet
25: Magnet cover
31: Housing
32: Bearing
33: Resolver
34: Resolver stator
35: Resolver rotor
36: Coil
41: Housing
42: Nut portion
43: Screw portion
44: Ball
45: Angular bearing
46a, 46b, Bearing fixing ring
47: Stepped portion
48: Bearing fixing ring
49: Stepped portion
51: Electric power steering device
52: Rack shaft
53: Motor
54: Ball screw mechanism
55: Steering shaft
56: Yoke
57: Magnet
58: Rotor shaft
59: Rotor core
Wt: Teeth width
Wy: Yoke portion width

### BEST MODE FOR CARRYING OUT THE INVENTION

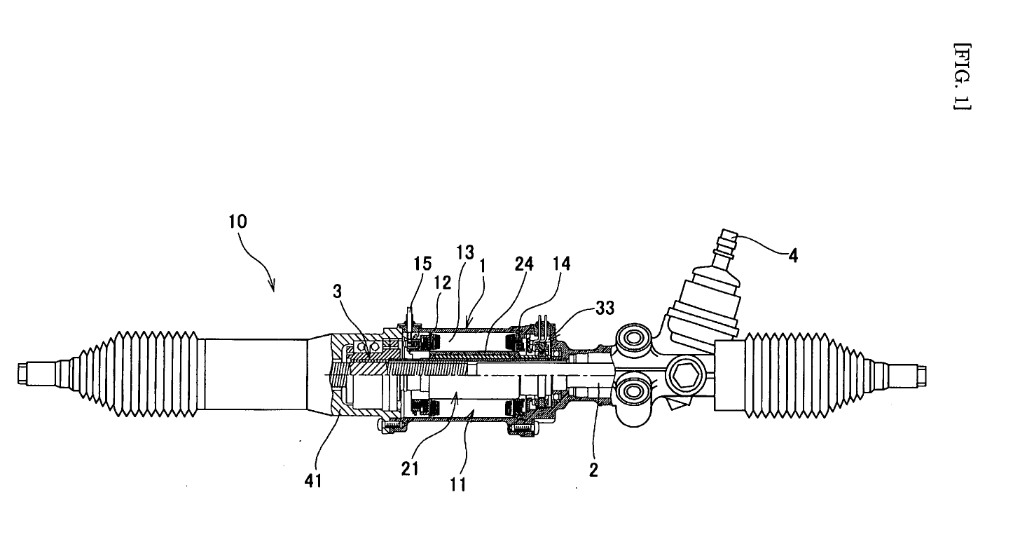

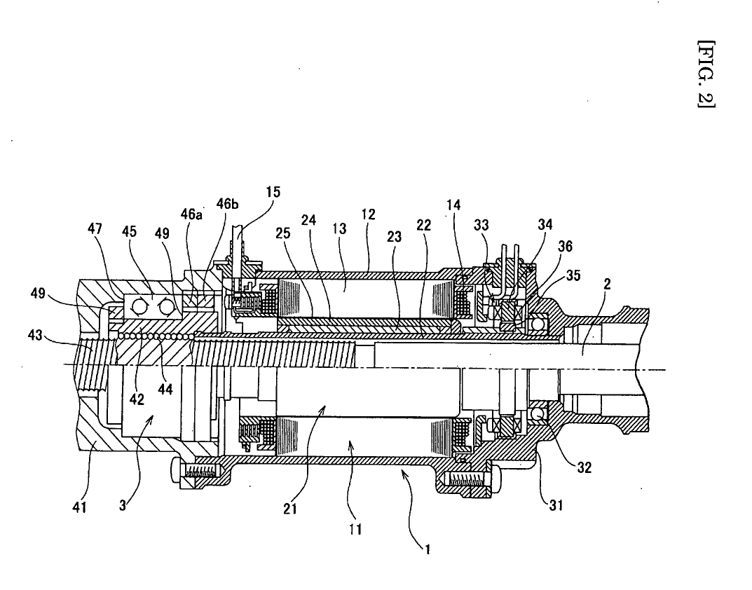

An embodiment of the present invention will be described in detail with reference to the accompanying drawings. FIG. 1 is a cross-sectional view showing a configuration of an electric power steering device which is an embodiment of the present invention. FIG. 2 is an enlarged cross-sectional view showing a configuration of an EPS motor used in the electric power steering device of FIG. 1. An electric power steering device (EPS) 10 of FIG. 1 has a rack-assist type structure as in the case of the EPS 51 of FIG. 6 and uses a motor 1 as a drive source. However, the EPS 10 differs from the EPS 51 of FIG. 6 in that it uses, as the motor 1, a brushless motor for achieving further miniaturization and higher performance.

A rack shaft 2 penetrates the inside of the motor 1 in a coaxial manner with the motor 1. A rotation of the motor 1 is transmitted to the rack shaft 2 through a ball screw mechanism 3 to become a steering assist force. Steering control wheels are connected to both ends of the rack shaft 2 through a not shown tie rod, knuckle arm, and the like. The rack shaft 2 is rack-and-pinion coupled to a steering shaft 4 and is moved in the axial direction (left-right direction in the figure) by driver's steering operation.

In the EPS 10, as in the case of the EPS 51 of FIG. 6, when a steering wheel is operated to rotate the steering shaft 4, the rack shaft 2 is moved in the direction corresponding to the rotation. As a result of the activation of the steering shaft 4, a not shown steering torque sensor is activated, and a power is appropriately supplied to the motor 1 based on the detected torque. When the motor 1 is activated, the rotation thereof is transmitted to the rack shaft 2 through the ball screw mechanism 3. Then, the rotation of the motor 1 is converted into movement in the axial direction of the rack shaft 2 by the ball screw mechanism 3, whereby a steering assist force is given to the rack shaft 2. The steering control wheels are steered by the steering assist force and a manual steering force.

The motor 1 is an inner rotor type brushless motor having a stator 11 outside thereof and a rotor 21 inside thereof. The stator 11 includes a housing 12, a stator core 13 fixed on the inner peripheral side of the housing 12, and a winding 14 wound around the stator core 13. The housing 12 is made of iron or the like and has an outer periphery equal to or less than 100 mm. The stator core 13 has a configuration obtained by stacking a large number of steel sheets. A plurality of teeth project from the inner peripheral side of the stator core 13.

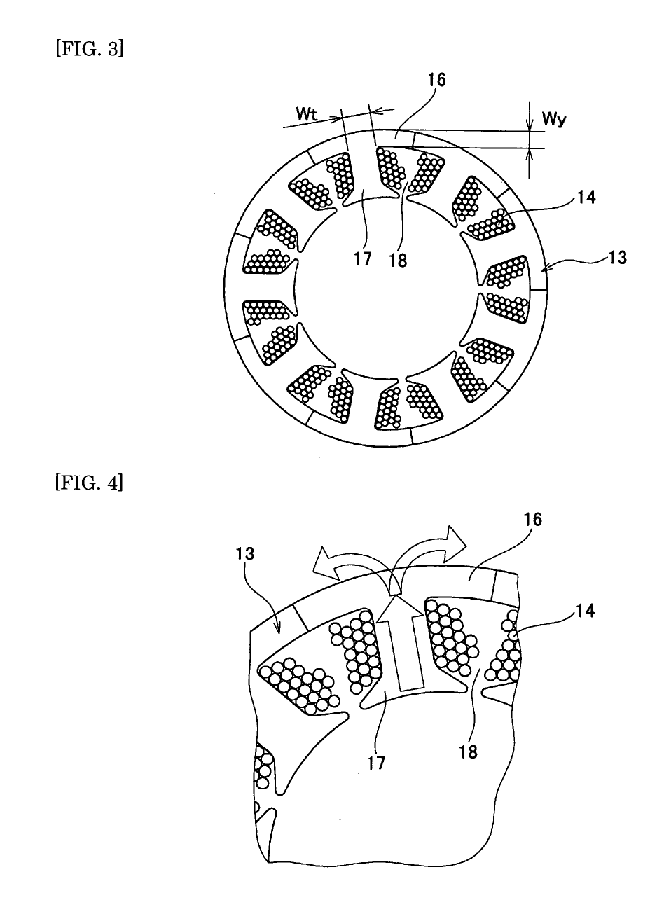

FIG. 3 is an explanatory view showing a configuration of the stator core 13. The stator core 13 is constituted by a ring-like yoke portion 16, and a teeth 17 projecting from the yoke portion 16 toward the inner side thereof. There are provided nine teeth 17 in the motor 1. A slot 18 (nine slots in total) is provided between respective teeth 17 and thus the motor 1 has a nine-slot structure. The winding 14 is wound around each teeth 17 in a concentrated manner. The winding 14 is housed in each slot 18. The winding 14 is connected to a battery (not shown) through a power supply wiring 15.

The rotor 21 is disposed inside the stator 11. The rotor 21 has a cylindrical rotor shaft 22, a rotor core 23, a magnet 24, and a magnet cover 25 which are disposed coaxially. The rack shaft 2 is inserted through the inside of the rotor shaft 22. A cylindrical rotor core 23 is fitted on the outer periphery of the rotor shaft 22. A six-pole magnet 24 is fixed around the outer periphery of the rotor core 23 and thus the motor 1 has six-pole and nine-slot structure.

A rare earth magnet such as a neodymium-iron magnet, which is compact in size and makes it possible to obtain a high magnetic flux density, is used as the magnet 24. The use of the rare earth magnet as the magnet 24 allows further miniaturization of the motor, as well as a reduction in inertia of the rotor 21 and achievement of excellent steering feeling. The magnet 24 has a ring-like shape, on which a plurality of magnetic poles are arranged in the circumferential direction such that N- and S-poles alternately appear. A plurality of segment magnets may be used as the magnet 24. A magnet cover 25 is fitted on the outside of the magnet 24. Even if the magnet 24 is broken, the magnet cover 25 prevents the motor 1 from being locked by the broken pieces.

A housing 31 made of aluminum diecast is fitted to the right end side in the figure of the housing 12. A bearing 32 for supporting the right end side of the rotor 21 and a resolver 33 for detecting the rotation of the rotor 21 are housed in the housing 31. The resolver 33 is constituted by a resolver stator 34 fixed on the housing 31 side and a resolver rotor 35 fixed to the rotor 21 side. A coil 36 is wound around the resolver stator 34, which includes an exciting coil and a detecting coil. The resolver rotor 35 is fixed to the rotor shaft 22 at the inside of the resolver stator 34. The resolver rotor 35 has a configuration which is obtained by stacking metal sheets and in which convex portions project in three directions.

When the rotor shaft 22 is rotated, the resolver rotor 35 is also rotated in the resolver stator 34. A high-frequency signal is supplied to the exciting coil of the resolver stator 34, and the phase of a signal output from the detecting coil is changed depending on the approach and recession of the convex portions to and from the exciting coil. By comparing the detection signal and a reference signal, the rotation position of the rotor 21 is detected. Based on the rotation position of the rotor 21, a current supplied to the winding 14 is appropriately changed so as to rotationally drive the rotor 21.

A housing 41 made of aluminum diecast is fitted to the left end side of the housing 12. The ball screw mechanism 3 is incorporated in the housing 41. The ball screw mechanism 3 is constituted by a nut portion 42, a screw portion 43 formed around the outer periphery of the rack shaft 2, and a large number of balls 44 provided between the nut portion 42 and screw portion 43. The rack shaft 2 is rotatably supported by the nut portion 42 so as to be reciprocated in the left-right direction and is moved in the left-right direction with the rotation of the nut portion 42.

The nut portion 42 is fixed to the left end portion of the rotor shaft 22 and is rotatably held by an angular bearing 45 fixed to the housing 41. The angular bearing 45 is fixed between bearing fixing rings 46a, 46b screwed in the opening portion of the housing 41 and a stepped portion 47 formed inside the housing 41 in such a manner that the movement of the angular bearing 45 in the axial direction is restricted. Further, the axial direction movement of the angular bearing 45 is restricted by a bearing fixing ring 48 screwed in the left end of the nut portion 42 and a stepped portion 49 formed around the outer periphery of the nut portion 42.

In the EPS 10, when a steering wheel is operated to rotate the steering shaft 4, the rack shaft 2 is moved in the direction corresponding to the rotation, whereby the steering operation is made. As a result, a not shown steering torque sensor is activated and, based on the detected torque, a power is supplied to the winding 14 from a battery through the power supply wiring 15. When a power is supplied to the winding 14, the motor 1 is activated to rotate the rotor shaft 22. The rotation of the rotor shaft 22 causes the nut portion 42 coupled to the rotor shaft 22 to be rotated, an axial direction steering assist force is transmitted to the rack shaft 2 by the action of the ball screw mechanism 3. As a result, the movement of the rack shaft 2 is promoted, assisting the steering force.

On the other hand, as described above, it is difficult to achieve both the securement of a sufficient torque and miniaturization of a motor at the same time in the EPS motor. As a result of the present inventors' repetitive studies for solving the above-described problems, we have found that there is a certain relationship between the magnetic resistance ratio between the yoke portion 16 and teeth 17 of the stator core 13 and output torque and that it is possible to maximize the output torque by setting the magnetic resistance ratio between the yoke portion 16 and teeth 17 within a predetermined range. Thus, it is possible to obtain the stator core 13 capable of maximizing the output torque under the restriction placed on the physical size, thereby enabling achievement of both the securement of a sufficient torque and miniaturization of the motor. The magnetic resistances of the yoke portion 16 and teeth 17 are proportional to the widths thereof if the magnetic resistance values thereof are the same. Therefore, in the present embodiment, it is assumed that the yoke portion 16 and teeth 17 have the same magnetic resistance value, and the following description will be made of the width ratio between the yoke portion 16 and teeth 17 in place of the magnetic resistance ratio.

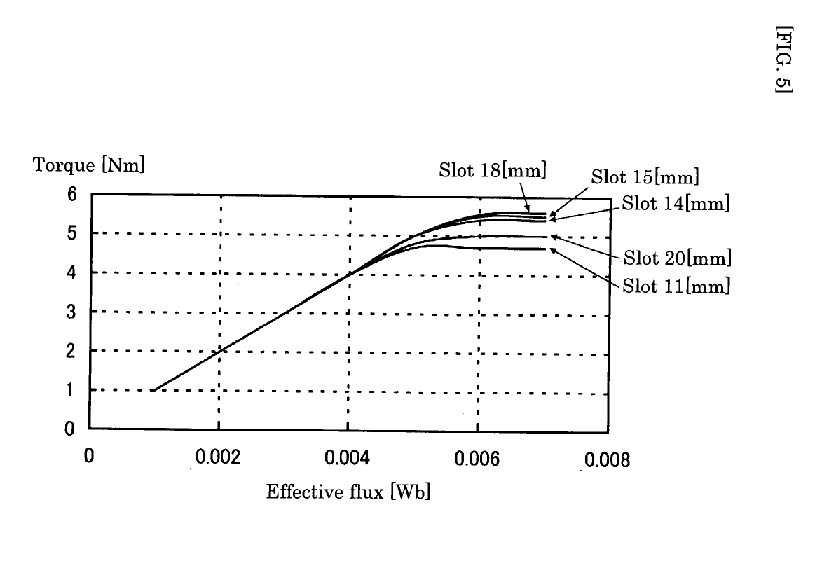

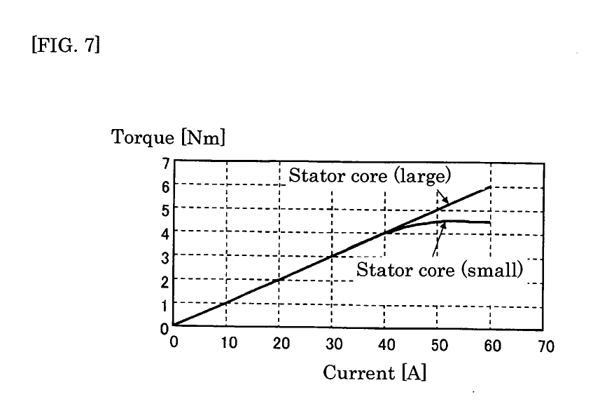

Here, a description will be made of a flux flow in the stator core 13. FIG. 4 is a partially enlarged view of the stator core 13, which explains a flux flow in the stator core. As shown in FIG. 4, a flux flow entering the teeth 17 dead-ends in the yoke portion 16 to be divided into two directions of left and right, and the respective flows go into the yoke portion 16. When the flux flow is blocked, the output of the motor 1 is decreased naturally. That is, when flux saturation occurs in both the teeth 17 and yoke portion 16, a torque slack occurs at high load time as shown in FIG. 7. Thus, in order to ensure the fullest extent of the output torque, it is necessary to prevent the magnetic saturation from occurring both in the yoke portion 16 and teeth 17. Therefore, it is necessary to set a width Wy of the yoke portion 16 and width Wt of the teeth 17 to optimum values so as to ensure the lowest possible width required for the flux to pass through within a restricted space (outer diameter).

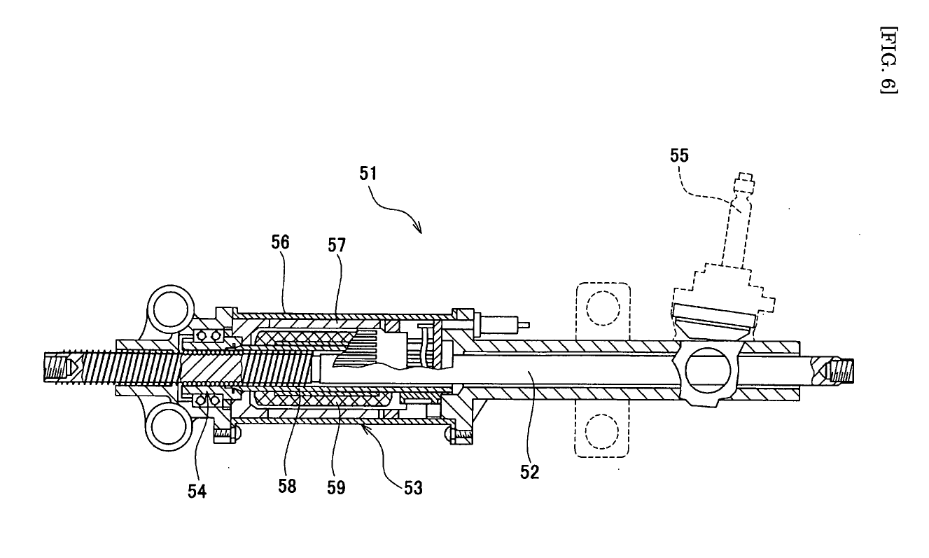

FIG. 5 is an explanatory view showing a relationship between an effective flux and torque, which shows a difference in the motor torque in the case where Wt is appropriately changed while Wy is fixed to 10 mm. The effective flux mentioned here is a flux effective for generating the motor torque. In FIG. 5, the effective torque is plotted on the horizontal axis in the interests of accuracy. That is, the torque depends not only on a winding current but also on the flux of a rotor magnet, so that when a current value is plotted on the horizontal axis, a torque characteristic changes depending on the specification of individual motors.

As shown in FIG. 5, experiments conducted by the present inventors revealed that when the ratio between the width Wy of the yoke portion 16 and width Wt of the teeth 17 was set in a range from 1:1.4 to 1:1.8, occurrence of a torque slack was suppressed. On the other hand, when the ratio is set to 1:1.1 (Wt=11 mm) or 1:2.0 (Wt=20 mm), the torque leveled off or decreased from the point where the effective flux was about 0.0045 Wb. It is considered that this is because, in the case of Wt=11 mm, there is still allowance for the increase in the flux in the yoke portion 16, while the magnetic saturation occurs in the teeth 17 to cause a torque slack and, in the case of Wt=20 mm, there is still allowance for the increase in the flux in the teeth 17, while the magnetic saturation occurs in the yoke portion 16 to cause a torque slack. Although the most satisfactory result was obtained in the case of Wt=18 mm in terms of the torque slack, the winding area in the slot 18 is reduced inversely with an increase in the width of the teeth 17. Thus, in terms of torque characteristic, the case of Wt=15 mm (Wy:Wt=1:1.5) which is not much different from the case of Wt=18 mm is believed to be optimum from a comprehensive standpoint.

As described above, when the ratio between Wy and Wt is set in the range from 1:1.4 to 1:1.8, it is possible to obtain a configuration, within a restricted space, that makes it difficult for the torque slack to occur in the stator core 13. Thus, according to the present invention, an EPS using a compact and high-performance motor excellent in layout and achieving high torque linearity can be provided. Further, in the EPS according to the present invention, the stator core 13 of the motor 1 is formed in an optimum shape to eliminate unnecessary portions, so that cost and weight of the motor 1 can be reduced. Accordingly, cost and weight of the EPS 10 can also be reduced, thereby enhancing the marketability of the EPS and eventually contributing to a reduction in fuel consumption.

The shape of the stator core is one of the most important points in designing a brushless motor since it exerts a strong influence on the motor performance. In this regard, in designing the motor 1 according to the present invention, since it is possible to determine the ratio between Wy and Wt, it is only necessary to determine specifications of respective parts of the motor in accordance with the abovementioned ratio. That is, according to the present invention, an optimum motor design guideline for the EPS can be obtained, making it easier to constitute a compact, high-output, and low cost EPS motor than ever before. Therefore, the EPS motor can optimally be designed, resulting in a reduction of man-hour required for designing the EPS motor. As a result, product development cost can be reduced and, accordingly, production cost of the EPS can be reduced.

The present invention is not limited to the embodiment described above but various modifications may be made without departing from the spirit and scope of the present invention.

For example, although the present invention is applied to a rack-assist type EPS in the above embodiment, the present invention may also be applied to a column-assist type EPS. Further, although the width ratio between the yoke portion 16 and teeth 17 is set to the abovementioned value (Wy:Wt=1:1.4 to 1:1.8) assuming that they have the same magnetic resistance value in the above embodiment, it is fundamentally possible to achieve optimum design by setting the ratio of the magnetic resistance between the yoke portion 16 and teeth 17 to the abovementioned value. Accordingly, in case the yoke portion 16 and teeth 17 of the stator core 13 are shown by the magnetic resistance value, the wide dimensions are set such that the ratio of the magnetic resistance becomes the above-mentioned value in accordance with the magnetic resistance value of each part.

Further, even in the case of the same material is used for the stator core 13, for example, in the case where silicon (Si) content in a silicon steel sheet is changed on a part-by-part basis, or in the case where a directional magnetic steel sheet is used, the magnetic resistance values may differ between the yoke portion 16 and teeth 17 in some cases. In the silicon steel sheet, as the amount of silicon increases, the magnetic resistance value increases. In the directional magnetic steel sheet, the magnetic resistance value becomes small in the rolling direction thereof. Therefore, in such a case, the wide dimensions are determined in consideration of the magnetic resistance value of each part. In general, a non-directional magnetic steel sheet is commonly used for a stator core of the motor. In such a case, since the magnetic resistance values of the yoke portion 16 and teeth 17 become the same, the width ratio between them is set to the abovementioned value.

Further, although the motor 1 is a six-pole nine-slot motor in the above embodiment, the number of poles or slots is not limited to this. In the case of motors with two-pole three-slot and motors in which the number of poles and slots are integral multiple of two and three, it is possible to achieve optimum design capable of suppressing occurrence of the torque slack by setting the magnetic resistance values of the yoke portion 16 and teeth 17 to the abovementioned value. Further, the present invention can be applied not only to an EPS using a motor with 12V power but also an EPS using a motor with 42V power.

1. An electric power steering device provided with a motor having a rotor with a permanent magnet and a stator arranged on an outer peripheral side of the rotor, characterized in that
the stator has a stator core provided with a ring-like yoke portion and a teeth portion projecting from the yoke portion in the inner direction, and
the stator core is formed such that the ratio of a magnetic resistance value between the yoke portion and teeth portion is set in a range from 1:1.4 to 1:1.8.

2. An electric power steering device provided with a motor having a rotor with a permanent magnet and a stator arranged on an outer peripheral side of the rotor, characterized in that
the stator has a stator core provided with a ring-like yoke portion and a teeth portion projecting from the yoke portion in the inner direction, and
the stator core is formed such that the ratio Wy:Wt between a width Wy of the yoke portion in the radial direction and width Wt of the teeth portion in the circumferential direction is set in a range from 1:1.4 to 1:1.8.

3. The electric power steering device according to claim 1, characterized in that
the motor is coaxially provided around a rack shaft connected to steering control wheels so as to supply a steering assist force to the rack shaft.

4. The electric power steering device according to claim 2, characterized in that
the motor is coaxially provided around a rack shaft connected to steering control wheels so as to supply a steering assist force to the rack shaft.
